(19) United States
(12) Patent Application Publication
(10) Pub. No.: US 2021/0336855 A1
(43) Pub. Date: Oct. 28, 2021

(54) METHOD FOR ESTABLISHING NETWORK CONNECTION BETWEEN SERVER AND NETWORK DEVICE

(71) Applicant: QNAP SYSTEMS, INC., New Taipei City (TW)

(72) Inventors: YENLUN CHEN, NEW TAIPEI CITY (TW); CHENGWEI LIN, NEW TAIPEI CITY (TW)

(21) Appl. No.: 17/196,373

(22) Filed: Mar. 9, 2021

(30) Foreign Application Priority Data
Apr. 28, 2020 (TW) 109114103

(51) Int. Cl. H04L 12/24; H04L 29/06; H04L 29/12

(52) U.S. Cl. CPC H04L 41/0873; H04L 41/0816; H04L 61/6022; H04L 67/42; H04L 41/0627

(57) ABSTRACT

A method is used for establishing network connection between a server and a network device, wherein the network device uses a dynamic host configuration protocol to obtain a network address in a specific network segment. After the server obtains a parameter set related to the network device and starts to establish a network connection to the network device, whether the network connection is stable is checked. When it is determined that the network connection is unstable and the server fails to connect to the network device, the server automatically searches the network addresses in the specific network segment to locate the network device, and connects to the network device when the network device is found.

### FIELD OF THE INVENTION

The present invention relates to a method for establishing network connection, and more particularly to a method for establishing network connection between a server and a network device. The present invention also relates to a network connection system, in which the method for establishing network connection is used.

### BACKGROUND OF THE INVENTION

In order to take advantage of capability of a server of centrally processing data and conducting calculations, a server is conventionally connected to multiple network devices via a network to process data generated by the multiple network devices and performing various types of calculations in response to requirements from the multiple network devices. For establishing network connections of the server and the network devices, the server reads predetermined network addresses to connect to the network devices. However, such a network connection establishment method cannot be easily applied to network devices that use Dynamic Host Configuration Protocol (DHCP) to obtain network addresses. Since a network device that obtains the network address through the dynamic host configuration protocol may be assigned thereto a different network address whenever it is started, it is necessary to frequently manually update the network address for the server to connect to the network device.

### SUMMARY OF THE INVENTION

Therefore, an object of the present invention is to provide a method for establishing network connection between a server and a network device, by which the server is capable of automatically locating and connecting to the network device.

The present invention provides a method for establishing network connection between a server and a network device, wherein the network device uses a dynamic host configuration protocol to obtain a network address in a specific network segment. The method comprises: the server obtaining a parameter set related to the network device, and starting to establish a network connection to the network device; checking whether the network connection is stable; and when it is determined that the network connection is unstable and the server fails to connect to the network device, the server automatically searching the network addresses in the specific network segment to locate the network device, and connecting to the network device when the network device is found.

The present invention provides a network connection system, which includes a server; a network; and a network device optionally connecting to the server via the network. For connecting to the server, the network device uses a dynamic host configuration protocol to obtain a network address of the network in a specific network segment, the server obtains a parameter set related to the network device and starts to establish a network connection to the network device. When the server determines that the network connection is unstable and the server fails to connect to the network device, the server automatically searches network addresses in the specific network segment to locate the network device, and connects to the network device when the network device is found.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is block diagram schematically illustrating a network connection system according to an embodiment of the present invention; and

FIG. 2 is a flowchart schematically illustrating a method for establishing network connection between a server and a network device according to an embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

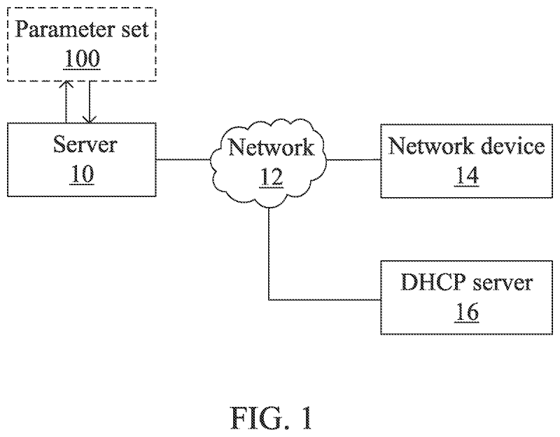

Please refer to FIG. 1. The network connection system includes a server 10, a network device 14 and a DHCP server 16, which are interconnected via a network 12. Therefore, the server 10 and the network device 14 can obtain a network address based on the DHCP algorithm.

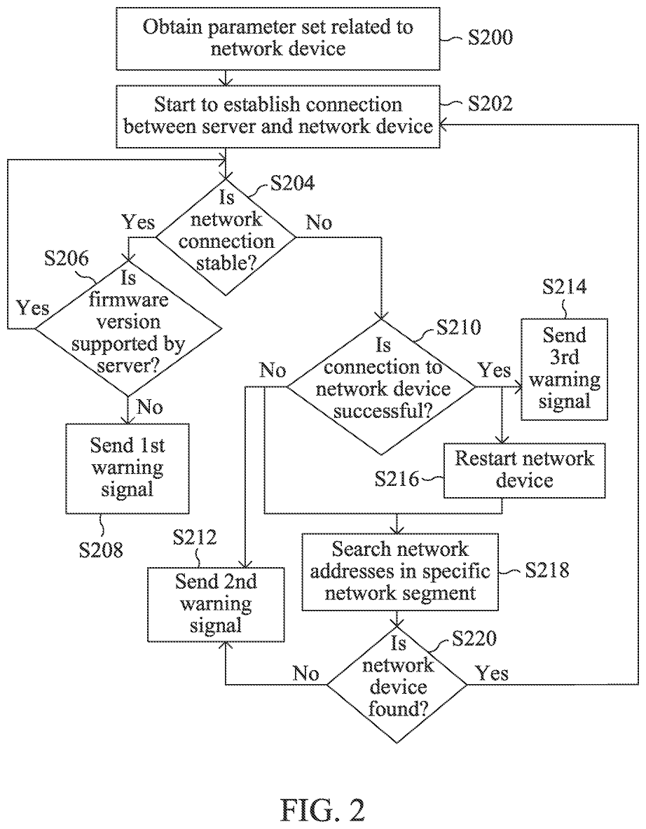

Further refer to FIG. 2. For connecting to the network device 14, the server 10 first obtains a parameter set 100 related to the network device 14 (Step S200). The parameter set 100 may be previously stored in the server 10 or obtained from an external source. Alternatively, the parameter set 100 may be dynamic data inputted into the server 10 via a user input interface. The parameter set 100, for example, may include various data useful for identifying the network device 14, such as a specific network segment where the network device 14 is located, a Media Access Control (MAC) address of the network device 14, and/or a network address assigned to the network device 14 by default.

After obtaining the parameter set 100, the server 10 starts to establish network connection to the device 14 according to the parameter set 100 (Step S202). For example, if the parameter set 100 includes a MAC address of the network device 14 and a specific network segment, the server 10 can search each of the MAC addresses in the specific network segment, and compares the MAC addresses with the MAC address contained in the parameter set 100. Once the server found an MAC address in compliance with the MAC address contained in the parameter set 100, it is determined the network device 14 to be connected is located. In another example, if the parameter set 100 includes a network address assigned to the network device 14 by default, the server 10 can directly connect to the network device 14 at the assigned network address. Of course, for reconfirmation, it is preferable that the parameter set 100 includes not only the assigned network address but also a MAC address of the network device 14. Then the searching process of consistent MAC address can be performed for double check. The searching process, for example, may be executed according to an Address Resolution Protocol (ARP), and the MAC address of the network device 14 and the located MAC address by searching can be recorded in an ARP Table.

Afterwards, the server 10 determines whether the connection to the network device 14 is stable or not (Step S204). If the network connection cannot be successfully established, the connection status is, of course, determined to be unstable. Furthermore, the connection status can be determined, for example, according to a data packet transmission condition. Concretely, if the server 10 successfully receives required data from the network device 14. In response to different requirements, the criteria for determining whether the connection in a network is stable or not may vary. For example, the server 10 may determine whether the connection to the network device 14 is stable or not according to a transmission condition of data packets and continuity of contents of the received data packets. If the server 10 receives no response to a connecting requirement from the network device 14, or some contents of the received data are missing, it is determined that the connection is unstable. It is understood that those skilled in the art may refer to other parameters to determine whether the connection is established or stable depending on practical requirements. For example, the network device 14 may automatically and regularly or optionally send a state-indicating signal to the server 10 to show a stable or unstable state thereof.

Provided that the connection between the server 10 and the network device 14 is stable enough for qualified data transmission, whether a firmware version of the network device 14 is supported by the server 10 is determined (Step S206). In practical, firmware versions which are surely supported by the server 10 are first obtained. For example, there may be a file recording a list of firmware versions supported by the server 10. Then the firmware version of the network device 14 is compared with the recorded firmware versions. If it is found to be in the list, it is determined that the firmware version of the network device 14 is supported by the server 10. Then after a period of time, the flow proceeds to Step S204 again to recheck the connection condition between the server 10 and the network device 14. It is understood by those skilled in the art, the length of the period of time may be predetermined according to practical requirements. On the contrary, if it is determined in Step S206 that the server 10 cannot support the firmware version of the network device 14, the server 14 issues and sends a first warning signal to notify a manager of the situation (Step S208).

On the other hand, if it is determined in Step S204 that the connection between the server 10 and the network device 14 is unstable, a series of checks and actions to respond to the unstable connection are automatically performed. It is understood that effective communication between the server 10 and the network device 14 requires, for example, unblocked network, successful connection of the network device 14 to the network, active state of the network device 14, common communication protocol between the server and the network device 14, etc. Therefore, one or more of the above-described factors may be checked in order to automatically perform trouble-shooting tasks.

For example, as illustrated in FIG. 2, the flow proceeds to Step S210, in which whether the server 10 is effectively connected to the network device 14 is checked, when it is determined in Step S204 that the connection between the server 10 and the network device 14 is unstable. If it is determined in Step S210 that the server 10 is not effectively connected to the network device 14, the server 10 issues a second warning signal to notify the manager of the situation (Step S212). Meanwhile or when triggered, the server 10 checks the previously obtained network addresses in the specific network segment (Step S218, which will be described in more detail later) in order to locate the network device and start to establish the connection to the network device again (Step S220). In this embodiment, Step S218 may be suspended and then triggered under a certain condition. For example, the condition may be under approval of the manager or after a predetermined period of time. On the contrary, if it is determined in Step S210 that the server 10 is effectively connected to the network device 14, while the connection status is unstable due to, for example, incapability of receiving data, high data-drop rate, low data flow, setting failure, etc., the network device 14 is restarted automatically or manually by the server 10 via proper means (Step S216). For example, if the network device 14 works with Power Over Ethernet (POE), the server 10 can restart the network device 14 by briefly cutting a power supply to the network device 14. Alternatively, the server 10 can control the network device 14 to restart by way of a Common Gateway Interference (CGI). Furthermore, a third warning signal may be issued and sent to notify the manager of the situation (Step S214).

Hereinafter, the detail of Step S218 is described. Basically, the server 10 searches network addresses by way of the Address Resolution Protocol (ARP). The server 10 queries one of the network addresses based on ARP to request a MAC address of the network device corresponding to this network address. If there is no such network device existing, the server 10 would not receive any response. On the other hand, if a specified network device responds to the query with its MAC address, the server 10 would receive the MAC address and updates the MAC address recorded in the ARP Table and corresponding to the specified network address with the received MAC address. Meanwhile, the server 10 compares the newly updated MAC address with the MAC address included in the parameter set 100 to identify whether the specified network device is the network device 14 or not. Upon finding the network device 14, the flow proceeds from Step S220 to S202 to restart the establishment of connection. If the network device 14 is found after all the network addresses included in the specific network segment are checked, the flow proceeds from Step S220 to Step S212, i.e. issuing and sending the second warning signal to the manager. Desirably but not necessarily, the current network address of the network device 14 is stored into the parameter set 100 for possible restarting later.

It is understood from the above descriptions that by way of the method for establishing network connection between a server and a network device according to the present invention, the DHCP network address of the network device can be automatically found. Therefore, the problems encountered in the prior art can be solved, so it is not necessary to frequently manually update the network address for the server to connect to the network device.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for establishing network connection between a server and a network device, the network device using a dynamic host configuration protocol to obtain a network address in a specific network segment, the method comprising:
the server obtaining a parameter set related to the network device, and starting to establish a network connection to the network device;
checking whether the network connection is stable; and
when the server determines that the network connection is unstable and the server fails to connect to the network device, the server automatically searching network addresses in the specific network segment to locate the network device, and connecting to the network device when the network device is found.

2. The method according to claim 1, wherein whether the network connection is stable is checked according to contents and continuity of data packets obtained by the server from the network device.

3. The method according to claim 1, further comprising: automatically checking whether a firmware version of the network device is supported by the server when the server determines that the network connection is stable.

4. The method according to claim 3, wherein whether the firmware version of the network device is supported by the server is determined by:
obtaining known firmware versions which are supported by the server;
comparing the firmware version of the network device with the known firmware versions; and
determining that the firmware version of the network device is supported by the server if the firmware version of the network device matches one of the known firmware versions.

5. The method according to claim 1, further comprising: automatically storing the network address of the network device to the parameter set when the server connects to the found network device at the network address.

6. The method according to claim 5, wherein whether a certain network device located while searching the network addresses in the specific network zone is the network device to be found is determined according to a comparing result of a MAC address of the certain network device and a MAC address of the network device recorded in the parameter set.

7. The method according to claim 1, wherein the server determines that the network connection is stable if the server sends a checking signal to the network device and then receives a feedback signal successfully from the network device, or if the server constantly receives a state-indicating signal from the network device.

8. The method according to claim 1, further comprising:
automatically restarting the network device when it is determined that the network connection is unstable but the server succeeds in connecting to the network device; and
the server automatically searching the network addresses in the specific network segment to locate the restarted network device, and connecting to the restarted network device when the restarted network device is found.

9. The method according to claim 7, further comprising: automatically storing the network address of the restarted network device to the parameter set when the server connects to the restarted network device at the network address.

10. The method according to claim 7, wherein the parameter set includes the specific network segment and a MAC address of the network device.

11. The method according to claim 9, wherein whether a certain network device located while searching the network addresses in the specific network zone is the restarted network device to be found is determined according to a comparing result of a MAC address of the certain network device and the MAC address included in the parameter set.

12. A network connection system, comprising:
a server;
a network; and
a network device optionally connecting to the server via the network,
wherein for connecting to the server, the network device uses a dynamic host configuration protocol to obtain a network address of the network in a specific network segment, the server obtains a parameter set related to the network device and starts to establish a network connection to the network device, and
when the server determines that the network connection is unstable and the server fails to connect to the network device, the server automatically searches network addresses in the specific network segment to locate the network device, and connects to the network device when the network device is found.
